(19) United States
(12) Patent Application Publication
(10) Pub. No.: US 2010/0104255 A1
(43) Pub. Date: Apr. 29, 2010

(54) SYSTEM AND METHOD FOR ORCHESTRAL MEDIA SERVICE

(76) Inventors: JaeKwan YUN, Daejeon (KR); Hae Ryong LEE, Daejeon (KR); Kwang Roh PARK, Daejeon (KR); Sung Won SOHN, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/505,655

(22) Filed: Jul. 20, 2009

(30) Foreign Application Priority Data
Oct. 28, 2008 (KR) 10-2008-0105763

(51) Int. Cl. H04N 5/91

(52) U.S. Cl. 386/66; 386/96

(57) ABSTRACT

A system for the orchestral media service which receives the orchestral media having multiple tracks and neodata from a media service provider and shares the data with multiple connected devices to play, includes: a client engine that parses the orchestral media to separate into each audio/video and neodata, combines the audio/video into one resource to play, synchronizes with the connected devices with a basis of the playback time of the main audio/video, analyzes the neodata, maps the neodata into control command to transfer to the connected devices, and outputs the mapped control command; and a communication interface that performs connection with the devices having respective communication systems and transfers the control command to the connected devices.

### CROSS-REFERENCE TO RELATED APPLICATIONS

The present invention claims priority of Korean Patent Application No. 10-2008-0105763, filed on Oct. 28, 2008, which is incorporated herein by reference.

### FIELD OF THE INVENTION

The present invention relates to a technique of playing media, more particularly, to a system and method for orchestral media service appropriate for playing media including multiple audio/videos and neodata synchronized with multiple active and passive devices through wired or wireless network.

### BACKGROUND OF THE INVENTION

Digital home will evolve into real-sense/intelligent ubiquitous home. The home digital devices present in the real and intelligent ubiquitous home will be interconnected through wired or wireless network. The home media device has undertaken a media playback by using an actuator. The actuator may be implemented by, e.g., a home server, a set-top box, a DTV (digital television) and the like in a home and by, e.g., a smart phone, a PDA(Personal Digital Assistants), PMP (Portable Media Player) and the like while moving. For example, media has been played by using a playback device such as a television in home. In the future, the media playback devices will cooperate with each other and play together to give more effects to users, and will be self-evolved and appropriate to the user's home, rather than processing playback of all media in one actuator. Until now, various media playing methods which use multiple devices together are being discussed regarding this matter.

As the number of media playback devices present at home increases and each device has a built-in function capable of playing media, however, since there is not enough playback method to play media through integrating the home appliances, therefore, the devices present at home are not fully used.

As described above, in the media playback system of state of the art, one media which is consist of one video and one audio is usually played on one playback device. Even though, when there are various devices capable of playing media at home, we only can use one device to play one media, because these devices are not support multiple audio/videos playing. If there are multiple audio/videos and effect data related with the specific scenes in one media, it is better to use all devices to play these media to maximize the effects of the media.

### SUMMARY OF THE INVENTION

In view of the above, the present invention provides a system and method for the orchestral media service capable of playing media including multiple audio/videos synchronized with multiple active devices, e.g., a PC, a PDA(Personal Digital Assistants), an UMPC (Ultra Mobile PC), a PMP (Portable Media Player), a PSP(PlayStation Portable) and the like and passive devices, e.g, a heating device, a lighting device, a shading device, temperature and humidity controller and the like through wired or wireless network.

Further, the present invention provides a system and method for the orchestral media service capable of transferring a media including multiple tracks to multiple active devices through wired or wireless network, and playing different audio/video included inside the orchestral media by multiple active devices and controlling passive devices to make non visual and audible effects (e.g., scent, smog, light, vibration, etc.) synchronized with a main audio/video played in an actuator.

In accordance with a first aspect of the present invention, there is provided a system for the orchestral media service which receives the orchestral media having multiple tracks and neodata from the media service provider and spread tracks over the multiple connected devices to play, the system including: a client engine that parses the orchestral media to separate into each audio/video track and neodata (contains effect data), synchronizes with the connected devices with a basis of the playtime of the orchestral media, analyzes the neodata, maps the effects data inside the neodata into control command that controls the effect devices connected with the actuator, and outputs the mapped control command to the passive devices; and a communication interface that performs connection with the devices having respective communication interface and transfers the control command to the connected devices.

In accordance with a second aspect of the present invention, there is provided a method for the orchestral media service, including: controlling that controls total time to play the orchestral media transferred from the media service provider, in the actuator performing connection with the active and the passive devices to perform continuous synchronization; separating that parses the orchestral media to separate into each audio/video data and neodata; playing back that plays the main audio/video(normally first track inside multiple tracks can be the main audio/video) on a media output device (e.g., DTV) connected with the actuator by performing synchronization and transfers other audio/video tracks except main audio/video to the user around active devices to play them synchronously with main audio/video; mapping that analyzes the neodata and changes the effect data inside the neodata into control command to activate the connected passive devices; and transferring that transfers the mapped control command to the passive devices and each audio/video except main audio/video to the active devices.

### BRIEF DESCRIPTION OF THE DRAWINGS

The objects and features of the present invention will become apparent from the following description of embodiments given in conjunction with the accompanying drawings, in which:

FIG. 1 illustrates a structure of the orchestral media service system in accordance with an embodiment of the present invention;

FIG. 2 illustrates an operation process of the passive device in accordance with the embodiment of the present invention;

FIG. 3 illustrates an operation process of the active device in accordance with the embodiment of the present invention;

FIG. 4 is a block diagram illustrating the client engine of the orchestral media service system shown in FIG. 1;

FIG. 5 is a block diagram illustrating a structure of the main controller shown in FIG. 4;

FIG. 6 is a block diagram illustrating a structure of the A/V player module shown in FIG. 4;

FIGS. 7A to 7C are block diagrams illustrating a structure of the parser module shown in FIG. 4, a data structure of the neodata, and the data structure for playing the neodata in accordance with the embodiment of the present invention, respectively;

FIG. 8 is a block diagram illustrating a structure of the synchronization module shown in FIG. 4;

FIG. 9 is a block diagram illustrating a structure of the active device shown in FIG. 4;

FIG. 10 is a block diagram illustrating a structure of the passive device shown in FIG. 4; and

FIG. 11 is a flow chart illustrating an operation procedure of the orchestral media service system in accordance with the embodiment of the present invention.

### DETAILED DESCRIPTION OF THE EMBODIMENTS

Hereinafter, exemplary embodiments of the present invention will be described in detail with reference to the accompanying drawings which form a part hereof.

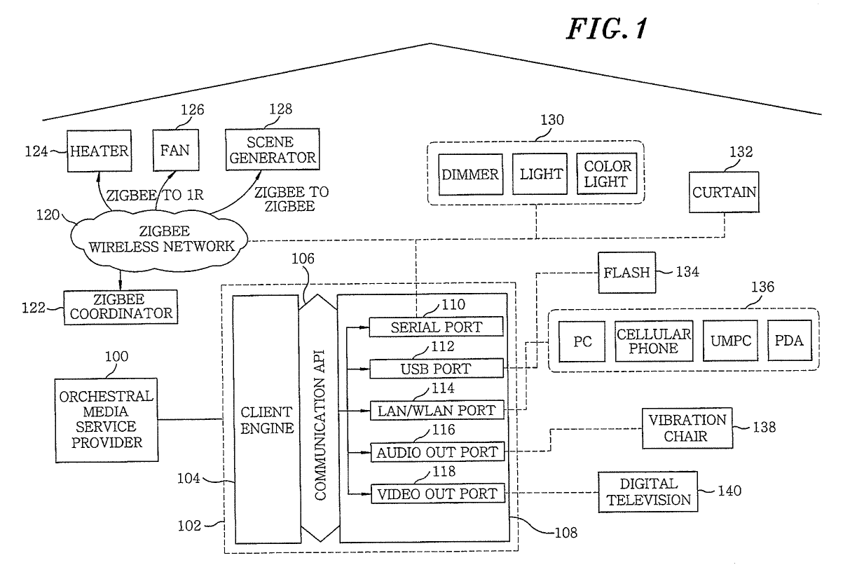

FIG. 1 illustrates a structure of the orchestral media service system in accordance with the embodiment of the present invention.

Referring to FIG. 1, the orchestral media service system receives the orchestral media from a service provider (SP) 100 and transfers the received orchestral media to the actuator 102.

A client engine 104 of the actuator 102 analyzes the transferred orchestral media to make multiple audio/videos playable on the respective active devices, transfers the corresponding media and neodata which is separated from the orchestral media to the user around passive devices respectively connected with interfaces 108 (serial port, USB port, LAN/WLAN port, audio out port, video out port) through a communication interface, which is an Application Program Interface (API) 106. Actually, active devices use WLAN/LAN interface to receive multiple audio/video tracks, and passive devices use serial port, USB port, audio out port, video out port and the like.

Specifically, the control data transferred through the control interface (e.g., serial port 110) is transferred to a ZigBee coordinator 122 through the ZigBee wireless network 120. The ZigBee coordinator 122 transfers the control data to the heater 124, fan 126, scent generator 128 and other devices.

Further, the serial port 110 can be used to transfer the control data to the lighting device 130 such as dimmer, light, color light and the like connected by control interface (e.g., RS-485 serial communication interface), and blind, curtain 132 and the like connected by control interface (e.g., RS-232 serial communication interface). A USB port 112 can be used to transfer the control data to a flash 134 connected by control interface (e.g., USB communication interface). A LAN/WLAN port 114 transfers the each audio/video to an appropriate active devices 136 linked by LAN/WLAN communication such as a computer, cellular phone, Ultra Mobile PC (UMPC), Personal Digital Assistants (PDA) and the like.

An electro machine such as vibration chair 138 can be connected to the control interface (e.g., audio out port 116 through audio cable), and digital television 140 is connected to the control interface (e.g., video out port 118 through a high definition multimedia interface (HDMI) cable) to transfer the media data to the corresponding devices.

An active device and a passive device used in the orchestral media service system may be a home appliance generally used in a home network, and can be a build-in equipment for example, smog machine, soap bubble generator and the like used to play a specialized effect.

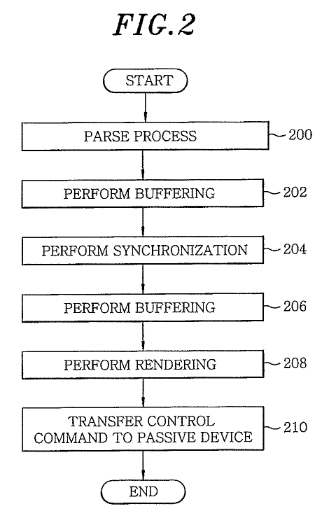

FIG. 2 illustrates an operation process of the passive device in accordance with an embodiment of the present invention.

Referring to FIG. 2, a parsing process is performed to analyze the media to be played in the actuator 102 in step 200. During the parsing process, multiple audio/video tracks and neodata which has effect data and synchronization information between audio/video track and neodata are extracted and stored in buffer in step 202. A synchronization process is performed to play simultaneously the respective multiple audio/video player located in an each active device and passive device to give other effect (e.g, wind effect, scent effect) to the user in step 204, the extracted audio/video and the neodata, synchronization information are stored in buffer in step 206.

Then, the main audio and video selected from the multiple audio/video tracks are delivered to the rendering process in step 208 and then played in the A/V player inside the actuator 102. The passive device that receives the control data is activated simultaneously in step 210.

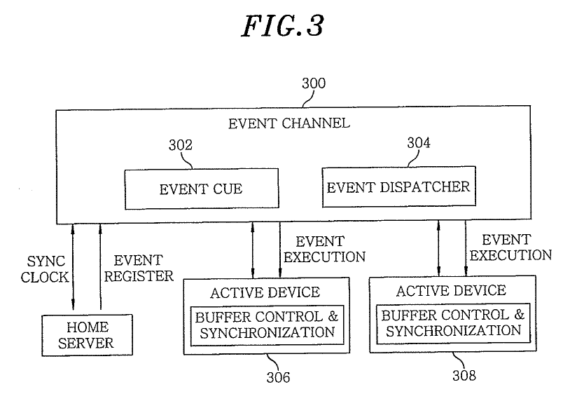

FIG. 3 illustrates an operation process of the active device in accordance with an embodiment of the present invention

Referring to FIG. 3, the active devices, for example, computer, digital television, and phone, include embedded operating system and can be operated by themselves. They are built-in with software to play separately transferred audio and video.

The media consist of several tracks is transferred to the actuator 102 and goes through the parsing process to be transferred to the respective active devices. Each active device and the actuator 102 continuously perform synchronization each other. Assuming that a time is synchronized, an event channel 300 is shared and, if a control command is generated in the event channel 300, the control command is registered in an event queue 302. The event control command registered in the event queue 302 is dispatched to the corresponding active devices 306 and 308 by the event dispatcher 304. The active devices 306 and 308 execute the event.

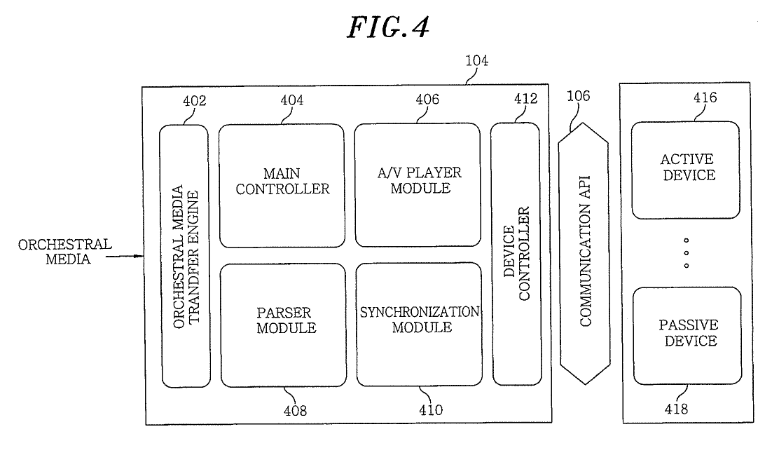

FIG. 4 is a block diagram illustrating the client engine of an orchestral media service system shown in FIG. 1.

Referring to FIG. 4, the client engine 104 includes a transfer engine 402, a main controller 404, an A/V player module 406, a parser module 408, a synchronization module 410 and a device controller 412. The orchestral media includes conventional audio, video and text as well as neodata having additional information of effect information to maximize playback effect of the media, device synchronization information, device link information (e.g., URL of the Web Browser) and the like.

Specifically, the orchestral media from the orchestral media service provider 100 is transferred to the main controller 404 of the client engine 104 through the transfer engine 402. The main controller 404 manages total time to play the orchestral media and parses the orchestral media to separate into each audio/video track and neodata, thereby transferring the separated data to the A/V player module 406 and the parser module 408. The A/V player module 406 synchronizes the audio/video data transferred from the main controller 404 to play. The parser module 408 analyzes the neodata transferred from the main controller 404 and maps the neodata into control command to transfer to the connected respective passive devices.

The synchronization module 410 receives the control command and synchronization information from the parser module 408 and synchronizes with the active and passive devices which the control command is to be transferred. Under synchronized state, the synchronization module 410 transfers the mapped control command to the device controller 412 and the device controller 412 confirms the passive devices 418 connected by using the communication API 106. Then, the device controller 412 determines and selects among the passive devices capable implementing the effect based on the transferred mapped control command, and transfers the implementable control command to the selected passive devices.

Further, multi-track sender 608 of the A/V player module 406 transfers each audio/video, separated from the orchestral media, except main audio/video to the user around active devices, which will be described in FIG. 6

Hereinafter, each block will be described in detail with reference to the following drawings.

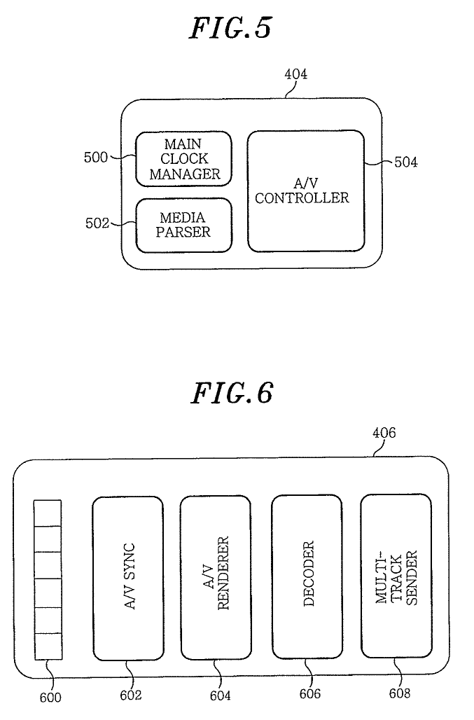

FIG. 5 is a block diagram illustrating a structure of the main controller shown in FIG. 4.

Referring to FIG. 5, the main controller 404 includes a main clock manager 500, a media parser 502, and an A/V controller 504. The main clock manager 500 manages a time affecting the whole actuator 102 and various devices. The main clock manager 500 manages the time with a basis of the main audio/video time played on the output devices connected with the actuator 102 and it is dependent on the built-in computer clock time. The media parser 502 performs parsing on the transferred orchestral media to separate into each audio/video tracks and neodata track including effect/synchronization information listed by time and scene. The A/V controller 504 transfers extracted main audio/video track to the A/V player module 406.

FIG. 6 is a block diagram illustrating a structure of the A/V player module shown in FIG. 4.

Referring to FIG. 6, the A/V player module 406 is responsible for playing the main audio/video on the actuator 102 and transfers audio/videos except main audio/video to the various user peripheral active devices. The A/V player module 406 includes an A/V buffer 600, an A/V sync 602, an A/V renderer 604, an H/W decoder 606 and the multi-track sender 608.

The A/V buffer 600 stores the audio/video tracks parsed from the media parser 502 and then transferred from the A/V controller 504 of the main controller 404. The audio sync 602 performs synchronization of the audio/video stored in the buffer. The A/V renderer 604 renders the synchronized audio/video into one resource. The H/W decoder 606 performs decoding to output the rendered resource in H/W. The multi-track sender 608 is responsible for transferring the audio/video of different tracks to the active device connected with the actuator 102 through wired or wireless interface.

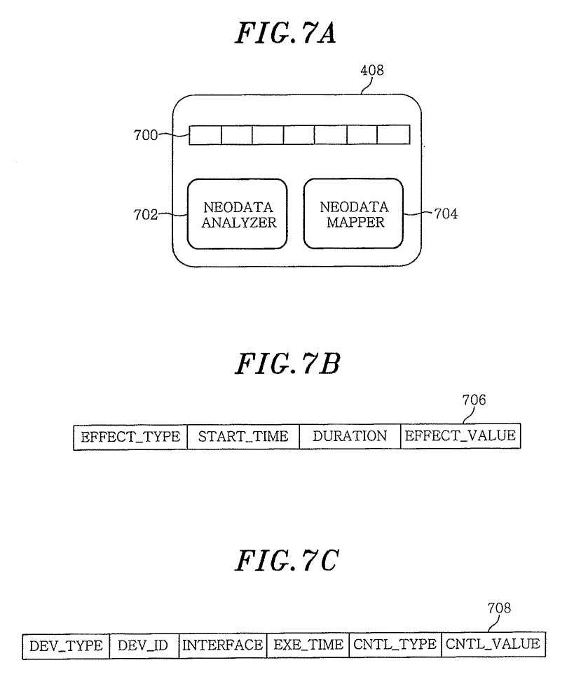

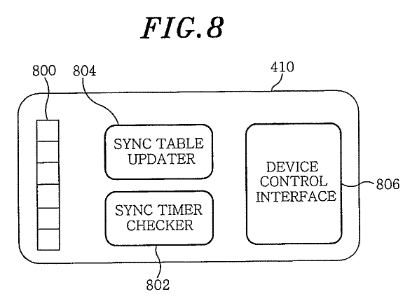

FIG. 7A is a block diagram illustrating a structure of the parser module shown in FIG. 4.

Referring to FIG. 7A, the parser module 408 analyzes the neodata parsed from the media parser 502 of the main controller 404. The parser module 408 includes a parsing table 700, a neodata analyzer 702, and a neodata mapper 704. The parsing table 700 is a buffer that storing the neodata parsed from the media parser 502 of the main controller 404. If the neodata is transferred in stream form, it means that neodata can be delivered serveral times like EPG(Electronic Program Guide), temporary buffer is required to store and analyze it. However, since such neodata is only to be transferred by certain amount for example, listed by time, scene and the like, the parse table 700 is used to temporarily store such neodata.

Since the neodata stored in the parsing table 700 includes only effect information about the audio/video transferred together, it is necessary that the neodata analyzer 702 analyzes the neodata stored in the parsing table 700 to convert effect data to control command. The neodata analyzer 702 analyzes the effect information included in the neodata to confirm a data structure included in the effect information. In the neodata mapper 704, the neodata, which effect information is analyzed in the neodata analyzer 702, undergoes a mapping process performing a transformation of data structure to be connected with the device actually connected with the actuator 102 and to be appropriate for executing the effect information in the corresponding device.

FIGS. 7B and 7C illustrate a data structure of the neodata, and the data structure for playing the neodata in accordance with an embodiment of the present invention, respectively.

An example of mapping the neodata is as follows. For example, the neodata of wind blowing scene as the data structure 706 shown in FIG. 7B can be represented with effect type, start time, duration, effect value and the like, having environmental information <WindEffect, 10.0s, 3.5s, 1 ms>. WindEffect means wind effect, 10.0s is a start time that the wind effect starts in the main audio/video, 3.5s is a duration time of the effect and 1 ms means a wind effect of 1m/second wind.

In order to play the above effect in the device at home, the neodata mapper 704 performs the transformation to control information <Electronic Fan, 1005, IR, 9s, 3 step control code, ON> and transfers to the synchronization module 410, since the neodata can be represented with device type, device identification number, connection interface, execution time, control type, control value and the like, as shown in FIG. 7C. Electronic Fan represents an electronic fan, 1005 is identification number of the electronic fan, IR represents wireless infrared rays communication, 9s is execution time, 3 step control code corresponds to control type, and ON means power on state.

FIG. 8 is a block diagram illustrating a structure of the synchronization module shown in FIG. 4.

Referring to FIG. 8, the sync part 410 includes a sync table 800, a sync timer checker 802, a sync table updater 804 and a device control interface 806. The sync table 800 is a buffer that storing the data mapped in the neodata mapper 704. The mapped neodata is stored in the sync table 800 by mapping sequential order.

The sync timer checker 802 continuously checks synchronization among the connected devices for example, active devices according to a time of the main clock manager 500. If there is an active device not synchronized, a synchronization set command is transferred to the unsynchronized active device. The sync table updater 804 is responsible for correcting control information so that the device executes ahead by considering an actual execution time. In the sync table updater 804, Equation 1 is used to calculate actual execution time. The actual execution time Eᵢ of each device is calculated by subtracting activation time Δt(dᵢ) of each device and network delay time Δt(nᵢ) from the start time(Ti) of each device.

Ei=Ti−Δt(dᵢ)−Δt(nᵢ) [Equation 1]

The passive device uses hardware and may have an error range to a certain extent, e.g., 40 μs or smaller. However, the active devices like computer and PDA internally scheduling with their own CPU have irregular execution times for respective processes. Therefore, there can be making an error in the activation time even if the control command from the actuator 102 is transferred instantly. Further, since current wired/wireless communication interfaces are not protocols insuring the real time characteristics, a delay concerning such situation is required to be considered. When calculating the device activation time, the sync table updater 804 distinguishes whether the device is active type or passive type. The activation time Δt(dᵢ) of each active or passive device can be obtained by using the following Equation 2.

$$Δ t ( {d}_{i} ) = \{ \begin{matrix}passive device \text{:} \begin{matrix}MAX ( {D}_{i} , \frac{{\sum }_{i = 0}^{n} {d}_{i}}{n} ) {D}_{i} \\ is obtained by H / W vender\end{matrix} \\ active device \text{:} \frac{{\sum }_{i = 0}^{n} SPDi + {SMAD}_{i} + {RPD}_{i} + {RMAD}_{i}}{n}\end{matrix} \} \qquad [ Equation 2 ]$$

Sender processing delay (SPD) is a delay time generated by the command processing time in the actuator 102 side, and sender media access delay (SMAD) is a time taken to read media in the actuator 102 side. Receiver processing delay (RPD) is a processing delay time of the active device receiving audio/video, and receiver media access delay (RMAD) is a time used to play audio/video on player of the active device.

A value of the network delay time Δt(nᵢ) for the passive device can be set 0 since it uses hardware and a value of the network delay time Δt(nᵢ) for the active device is obtained by a delay value produced when transferring through wired/wireless communication.

The device control interface 806 is connected with the device controller 412 shown in FIG. 4. The device controller 412 transfers control command to the connected passive devices 418, and receives a confirming message of each control command from each device through the communication API 106.

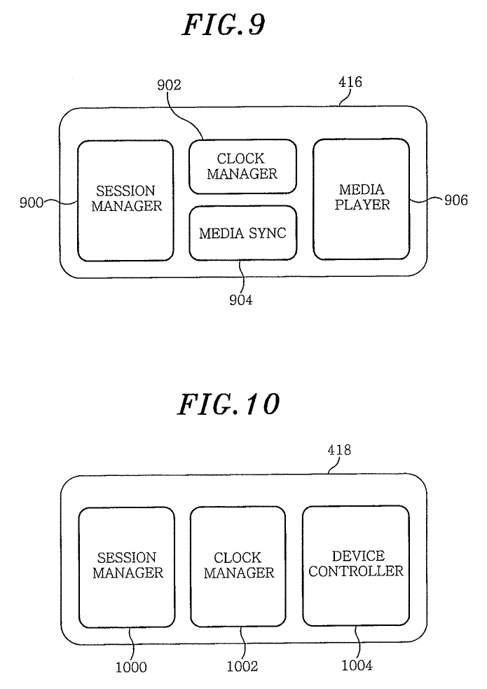

FIG. 9 is a block diagram illustrating a structure of the active device shown in FIG. 4.

Referring to FIG. 9, the active device 416 includes a session manager 900 maintaining connectivity with the actuator 102, a clock manager 902 managing time for synchronization, a media sync 904 synchronizing with the actuator 102 when playing media as well as correcting, and a media player 906 playing audio/video transferred to the active device.

FIG. 10 is a block diagram illustrating a structure of the passive device shown in FIG. 4.

Referring to FIG. 10, the passive device 418 includes a session manager 1000 maintaining connectivity with the actuator 102, a clock manager 1002 managing time for synchronization with the actuator 102, and a device controller 1004 controls passive device.

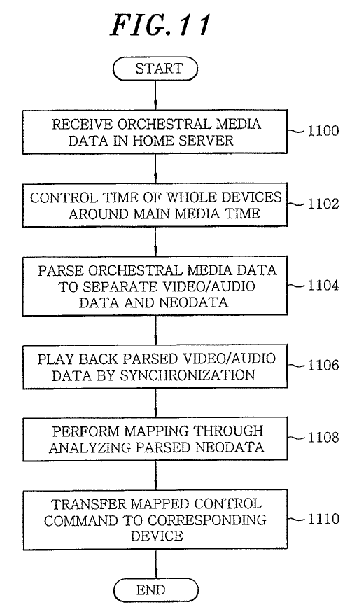

FIG. 11 is a flow chart illustrating an operation procedure of the orchestral media service system in accordance with the embodiment of the present invention.

Referring to FIG. 11, the actuator, which has performed connection with the active and the passive devices to perform continuous synchronization with the connected devices, is input the orchestral media from the media service provider in step 1100. Then, the main clock manager 500 inside the main controller 404 controls the total time to play the orchestral media in step 1102. A playback time of the main audio/video in the A/V player module 406 can be used as a reference time for the control.

The media parser 502 parses the orchestral media to separate each audio/video and neodata in step 1104. The parsed audio/videos are transferred to the A/V player module 406. In step 1106, the A/V player module 406 synchronizes the audio/video, renders audio/video data through rendering process and decoding process. When there are multiple audio/videos in one orchestral media, the parser divides them into each part, and the multi-track sender sends separated track to the active device. To determine an active device, actuator must know the capacity of active device. When active device receives separated audio/video, it plays the audio/video with main audio/video with synchronized way.

In step 1108, the neodata is sent to the parser module 408 where an analysis of the neodata is performed and mapping of the neodata which converts neodata into control command executable in the corresponding device is performed. Then in step 1110, the device controller 412 receives the mapped control command from the parser module 408 and send control command to the passive devices to activate effect devices, the A/V player module 406 plays main audio/video on output device like television, and transfers other audio/videos separated from the orchestral media to the corresponding active devices to play audio/videos synchronously with main audio/video. After this step, main audio/video, other audio/video, and effect data play individually on different devices, with the help of the synchronization process, each device can make a harmony. Namely, they play apart, they can make synchronization.

The described orchestral media service system plays multiple audio/videos by using several active devices and activates multiple passive devices to give another effects from the different playback way of one media by using one device, thereby increases an applicability of media and may be used for playback at once by 3D media (e.g., there's 3 audio/video tracks in one orchestral media for an car advertisement, first track contains front shot of the car, second track contains left shot and third track contains right shot of the car. These track plays together and can give 3D effects to users) in home media service and dome shape (360-degree view) theater through attaching many small media outputs in series, if more number of audio/video tracks and the active devices are used, and a method of playback is adjusted.

As described above, the present invention, that embodies playing of media including multiple audio/videos through wired/wireless network synchronized with multiple active and passive devices, transfers media including multiple tracks to multiple active devices through wired/wireless network and plays different audio/videos included inside the media in multiple active devices and passive devices synchronized with a main audio/video played in an actuator.

While the invention has been shown and described with respect to the embodiments, it will be understood by those skilled in the art that various changes and modifications may be made without departing from the scope of the invention as defined in the following claims.

What is claimed is:

1. A system for the orchestral media service which receives the orchestral media having multiple audio/video tracks and neodata from a media service provider and shares the data with multiple connected devices to play, the system comprising:
a client engine that parses the orchestral media to separate into each audio/video and neodata, renders main the audio/video from the multiple audio/videos on output device like television, synchronizes with the connected devices with a basis of the main audio/video's playback time, analyzes the neodata, maps the effect data of the neodata into control command to activate the connected passive devices; and
a communication interface that performs connection with the devices having respective communication systems and transfers the control command to the connected passive devices.

2. The system of claim 1, wherein the client engine includes:
a main controller that manages current synchronization time to play the orchestral media and parses the orchestral media to separate into each audio/video and neodata;
an A/V player module that plays the main audio/video transferred from the main controller;
a parser module that analyzes the neodata received from the main controller and maps the effect inside the neodata into control command to activate the connected passive devices;
a synchronization module that receives the playtime of the main audio/video from the A/V player module and the execution time and control command for passive devices from the parser module and synchronizes with the active devices which receives each audio/video track except main audio/video and passive devices which the control command is to be transferred; and
a device controller that performs connection with the active and passive devices and transfers the control command to the connected active and passive devices.

3. The system of claim 2, wherein the main controller includes:
a main clock manager that manages the whole devices times with a basis of the main audio/video time played through the A/V player module;
a media parser that parses the orchestral media to separate multiple audio/video tracks and neodata including effect information listed by time and scene; and
an A/V controller that transfers the separated multiple audio/video tracks to the A/V player module.

4. The system of claim 2, wherein the player part includes:
a buffer that stores the audio/video data transferred from the main controller;
a sync that synchronizes the audio/video data stored in the buffer;
a renderer that renders the synchronized audio/video data to make it one resource;
a decoder that decodes the rendered resource to output; and
a multi track sender that transfers the audio/video data of different tracks to the connected active device through wired or wireless interface.

5. The system of claim 2, wherein parser module includes:
a parsing table that stores the neodata received from the main controller to perform buffering;
a neodata analyzer that analyzes an effect information included in the neodata to confirm a data structure; and
a neodata mapper that maps the analyzed control command through transforming into control command appropriate for respective devices.

6. The system of claim 5, wherein the data structure of neodata comprises at least one among, effect type, start time, duration, and effect value.

7. The system of claim 2, wherein the synchronization module includes:
a sync table that performs buffering on the mapped data received from the parser module;
a sync time checker that continuously checks synchronization among the connected active devices in accordance with a time of the main clock manager;
a sync table updater that corrects control information by considering an actual execution time of the connected devices; and
a device control interface that is connected with the device controller to send control command and receive feedback.

8. The system of claim 7, wherein the actual execution time of the devices is calculated by subtracting activation time of device and network delay time from start time of device.

9. The system of claims 8, wherein the execution time, when the device is an active device, is:
a sum of a delay time produced to process command and a time taken to read media in actuator side, a processing delay time in the active device receiving audio/video data and a time used to play audio/video data.

10. The system of claims 2, wherein the control command mapped in the parser module comprises:
at least any one among device type, device identification number, connection interface, execution time, control type and control value.

11. The system of claim 2, wherein the device controller performs connection with the active devices or passive devices through communication application program interface and sends control command and receives feedback with the connected active or passive devices.

12. A method for the orchestral media service, comprising:
controlling that controls total time to play the orchestral media transferred from the media service provider, in the actuator performing connection with active and passive devices to perform continuous synchronization;
separating that parses the orchestral media to separate into each audio/video data and neodata;
playing back that plays the audio/video data by performing synchronization;
mapping that analyzes the neodata and maps the neodata into control command to transfer to the connected respective devices; and
transferring that transfers the mapped control command to the passive devices and each audio/video except main audio/video to the active devices.

13. The method of claim 12, wherein the playing back process includes:
a synchronization that synchronizes each audio/video data;
a rendering that combines the synchronized audio/video data into one resource;
a decoding that decodes the combined resource; and
a transferring that transfers the decoded resource to the corresponding devices.

14. The method of claim 12, wherein the mapping process includes:
a buffering that stores the neodata and performs buffering;
a confirming that analyzes a data structure of the neodata and confirms control command to realize effect information included in the neodata; and
an appropriate mapping that maps the confirmed control command through transforming into control command appropriate for respective devices.

15. The method of claim 14, wherein the data structure of neodata comprises at least one among, effect type, start time, duration and effect value.

16. The method of claim 12, further comprising:
a buffering that performs buffering of the mapped control command for continuous synchronization in the actuator; and
a performing that corrects control information and controls synchronization time by considering an actual execution time of the connected devices.

17. The method of claim 16, wherein the actual execution time of the devices is calculated by subtracting execution time of device and network delay time from start time of device.

18. The method of claim 17, wherein the execution time, when the device is an active device, is a sum of a delay time produced to process command and a time taken to read media in the actuator side, a processing delay time in the active device receiving audio/video data and a time used to play the audio/video data.

19. The method of claim 12, wherein the mapped control command includes at least any one among device type, device identification number, connection interface, execution time, control type and control value.

20. The method of claim 12, wherein the transferring process that transfers the mapped control command performs connection with the active devices or passive devices through communication application program interface and communicates control command and data with the connected active or passive devices.
